(19) United States
(12) Patent Application Publication
(10) Pub. No.: US 2026/0018317 A1
(43) Pub. Date: Jan. 15, 2026

(54) DEVICE FOR PROVIDING AN ELECTRICALLY CONDUCTIVE CONNECTION BETWEEN TWO CONTACT POINTS WHICH CAN BE MOVED LINEARLY RELATIVE TO ONE ANOTHER

(71) Applicant: KOSTAL Automobil Elektrik GmbH & Co. KG, Lüdenscheid (DE)

(72) Inventors: Frank Bläsing, Werl (DE); Jens Maciejewski, Dortmund (DE)

(73) Assignee: KOSTAL Automobil Elektrik GmbH & Co. KG, Lüdenscheid (DE)

(21) Appl. No.: 19/330,979

(22) Filed: Sep. 17, 2025

Related U.S. Application Data
(63) Continuation of application No. PCT/EP2024/059266, filed on Apr. 4, 2024.

(30) Foreign Application Priority Data
Apr. 6, 2023 (DE) 10 2023 108 907.2

(51) Int. Cl. H01B 7/06; B60R 16/02; B65H 75/42; B65H 75/48; H01B 7/08

(52) U.S. Cl. CPC H01B 7/06; B60R 16/0215; B65H 75/425; B65H 75/486; H01B 7/08

(57) ABSTRACT

A coil spring arrangement for providing an electrically conductive connection between movable first and second contact points is provided. The coil spring arrangement includes a stator, a rotor, first and second cables, and a cable connection point. A first end of the first cable is connectable to the first contact point, a first end of the second cable is connectable to the second contact point, and respective second ends of the first and second cables are connected at the cable connection point. The first cable is unwindable from a drum forming the rotor against a force of a return apparatus. The second cable is situated in a winding gap delimited by an outer surface of the stator and an inner surface of the rotor with the first end of the second cable being fastened to the stator and the second end of the second cable being fastened to the rotor.

### CROSS-REFERENCE TO RELATED APPLICATIONS

This application is a continuation of International Application No. PCT/EP2024/059266, published in German, with an international filing date of Apr. 4, 2024, which claims priority to DE 10 2023 108 907.2, filed Apr. 6, 2023, the disclosures of which are hereby incorporated in their entirety by reference herein.

### TECHNICAL FIELD

The present invention relates to a device for providing an electrically conductive connection between two contact points that are linearly movable relative to one another.

### BACKGROUND

Such devices are used in applications in which two elements that are movable relative to one another are electrically connected. This is the case, for example, with the seats of a motor vehicle, which are movable over a certain distance in the longitudinal direction of the vehicle but are still equipped with electrical consumers such as variable displacement motors or heaters. At the present time, the electrical contacting generally takes place via cable sets situated underneath the seat which are dragged along over the travel path. Although it would also be conceivable here to use sliding contact rails, this is not appropriate due to possible contact problems resulting from soiling or damage, for example.

While the mentioned contacting via a cable harness or looped cable set that is dragged along is acceptable for customary vehicle seats thus far, this will not necessarily be the case in the future. Namely, seats in future vehicles will have greatly expanded movement options. These include a longitudinal adjustment which extends far beyond the length of the seat itself, and which can easily be greater than one meter. For long travel paths this would result in exposed cable sets, which is neither visually nor safety-wise acceptable.

### SUMMARY

An object is a robust and visually appealing electrical contacting for power applications and data applications with particularly long travel or movement paths.

Such electrical contacting is provided by a device in accordance with embodiments of the present invention.

In carrying out the above and/or other objects, a device for providing an electrically conductive connection between first and second contact points which can be moved relative to one another is provided. The device is designed in such a way that the first contact point is electrically connected to a first end of a first cable, and the second contact point is electrically connected to a first end of a second cable. Respective second ends of the first and second cables are electrically connected to one another at a cable connection point. The first cable can be unwound from a drum against a force of a return apparatus. The drum forms a rotor part of a coil spring arrangement. The rotor part is arranged to be rotatable about its longitudinal axis, coaxially with respect to a fixed cylindrical stator part of the coil spring arrangement. The second cable is situated in a winding gap that is delimited by the outer lateral (or circumferential) surface of the stator part and the inner lateral (or circumferential) surface of the rotor part in such a way that its first end is fastened to the stator part and its second end is fastened to the rotor part.

Different requirements for electrical and mechanical properties of the device may be met, among other ways, via different designs of the second cable. In one advantageous embodiment, it is therefore provided that the second cable is formed by multiple ribbon cables. The multiple ribbon cables are preferably situated or arranged in the winding gap in such a way that they are wound in opposite directions with a first section of their length resting against the outer surface of the stator part and with a second section of their length resting against the inner surface of the rotor part, so that a U-shaped turning section that reverses the winding direction is formed between the two sections of the ribbon cables.

In addition, at least one of the multiple ribbon cables may be designed as a dummy cable without electrical strip conductors (or electrical conductor tracks).

Also, in carrying out the above and/or other objects, a coil spring arrangement for providing an electrically conductive connection between first and second contact points that can be moved linearly relative to one another is provided. The coil spring arrangement includes a stator, a drum forming a rotor that is rotatable with respect to the stator, a first cable having a first end and a second end, a second cable having a first end and a second end, and a cable connection point. The first end of the first cable is electrically connectable to the first contact point, the first end of the second cable is electrically connectable to the second contact point, and the second ends of the first and second cables are electrically connected to one another at the cable connection point. The first cable is unwindable from the drum against a force of a return apparatus. The second cable is situated in a winding gap that is delimited by an outer surface of the stator and an inner surface of the rotor in such a way that the first end of the second cable is fastened to the stator and the second end of the second cable is fastened to the rotor.

Further, in carrying out the above and/or other objects, an assembly is provided. The assembly includes first and second contact parts and a coil spring arrangement. The first and second contact parts are linearly movable relative to one another. The coil spring arrangement includes a stator and a rotor that is rotatable with respect to the stator, a first cable having a first end and a second end, a second cable having a first end and a second end, and a cable connection point. The first contact part is electrically connected to the first end of the first cable, the second contact part is electrically connected to the first end of the second cable, and the second ends of the first and second cables are electrically connected to one another at the cable connection point whereby an electrically conductive connection is provided between the first and second contact parts. The first cable is unwindable with rotation of the rotor against a force of a return apparatus. The second cable is situated in a winding gap, delimited by an outer surface of the stator and an inner surface of the rotor, in such a way that the first end of the second cable is fastened to the stator and the second end of the second cable is fastened to the rotor.

The second cable may be formed by individual ribbon cables. In this case, a first section of the ribbon cables rest against the outer surface of the stator and a second section of the ribbon cables rest against the inner surface of the rotor, the first and second sections of the ribbon cables being wound in opposite directions so that a U-shaped turning section that reverses a winding direction is formed between the first and second sections of the ribbon cables.

The first contact part may be a first connector, and the second contact part may be a second connector. The first connector may be of a first cable harness, and the second connector may be of a second cable harness. The first cable harness may be a seat cable harness. The first connector may be linearly movable relative to the second connector.

### BRIEF DESCRIPTION OF THE DRAWINGS

Further advantageous embodiments of the subject matter according to the present invention are explained in greater detail with reference to an exemplary embodiment that is illustrated in FIG. 1.

FIG. 1 is a schematic illustration of a device in accordance with an exemplary embodiment of the present invention, in a side view.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

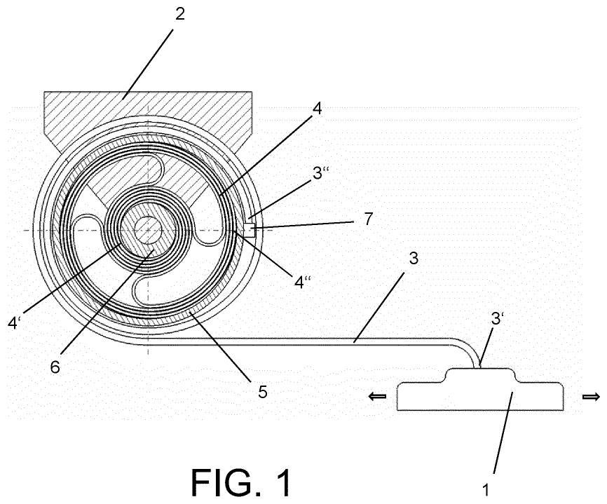

Referring now to FIG. 1, a side view schematic illustration of a device, in accordance with an exemplary embodiment of the present invention, for providing an electrically conductive connection between a first contact point 1 and a second contact point 2 that can be moved relative to one another, is shown. As indicated in FIG. 1, first contact point 1 is linearly movable along a direction indicated by the arrows.

The device includes a coil spring arrangement having a stator 6 and a drum forming a rotor 5. Stator 6 is fixed in place. Rotor 5 is rotatable with respect to stator 6. The device further includes a first cable 3 having a first end 3′ and a second end 3″ and a second cable 4 having a first end 4′ and a second end 4′.

First contact point 1 is electrically connected to first end 3′ of first cable 3. First contact point 1 is preferably designed as a plug connector to which a mating plug connector in this case, which is part of a seat cable or wiring harness, for example, is connected.

Second contact point 2 is electrically connected to first end 4′ of second cable 4. Here, second contact point 2 is fixed in position. Second contact point 2 likewise is preferably designed as a plug connector to which a matching mating plug connector, which is part of a vehicle cable or wiring harness, for example, may be connected.

Of course, in a departure from the design illustrated here, it is also possible for first contact point 1 to be fixed in position and for second contact point 2 to be designed to be movable with respect to the first contact point.

The respective second ends 3″, 4″ of first and second cables 3, 4 are electrically connected to one another at a cable connection point 7, so that overall, an electrically conductive connection is established between two contact points 1, 2 which are linearly movable relative to one another.

To enable the linear movability of first contact point 1, first cable 3 is unwindable from the drum against the force of a return apparatus (not shown). The return apparatus may be designed, for example, as a spring in the manner of a watch spring, which is in its relaxed position when first cable 3 is completely wound up. Unwinding first cable 3 tensions the spring, which upon discontinuation of the unwinding force winds first cable 3 back onto the drum. An alternative design of the return apparatus could be implemented by a gear coupling to the relative movement of the two elements (i.e., first and second contact points 1, 2) which are movable with respect to one another, and which are in electrical connection with one another by means of the device.

The drum forms rotor 5 of the coil spring arrangement. Stator 6 is a fixed cylindrical stator. Rotor 5 is arranged so that it is rotatable about its longitudinal axis, coaxially with respect to fixed cylindrical stator 6.

Second cable 4 is formed by at least one ribbon cable situated in a winding gap that is delimited by the outer lateral or circumferential surface of stator part 6 and the inner lateral or circumferential surface of rotor part 5. First end 4′ of second cable 4, which is electrically connected to second contact point 2 which in this case is fixed in position, is thus fastened to stator 6. Second end 4″ of second cable 4 is fastened to rotor 5, and at cable connection point 7 is electrically connected to second end 3″ of first cable 3.

In the illustrated embodiment, second cable 4 is formed by four individual ribbon cables that are situated in the winding gap in such a way that with a first section of their length resting against the outer surface of stator 6, and with a second section of their length resting against the inner surface of rotor 5 they are wound in opposite directions, so that a U-shaped turning section that reverses the winding direction is formed between the respective two sections of the ribbon cables.

At least one of the four ribbon cables has at least one electrical strip conductor that forms a galvanic connection between two contacts of the respective first contact point 1 and second contact point 2. However, multiple parallel strip conductors will generally be present, which in each case connect two contacts to one another. In addition, further cables of the present ribbon cables will have one or more strip conductors for the connection of contacts. However, if only a smaller number of strip conductors is necessary, one or more of the ribbon cables may also be designed as so-called dummy cables, i.e., without electrical strip conductors.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A device for providing an electrically conductive connection between first and second contact points that can be moved relative to one another, wherein the first contact point is electrically connected to a first end of a first cable and the second contact point is electrically connected to a first end of the second cable, wherein respective second ends of the first and second cables are electrically connected to one another at a cable connection point, wherein the first cable can be unwound from a drum against a force of a return apparatus, the drum forming a rotor part of a coil spring arrangement, the rotor part being arranged so that the rotor part is rotatable about its longitudinal axis, coaxially with respect to a fixed cylindrical stator part of the coil spring arrangement, and wherein the second cable is formed by at least one ribbon cable situated in a winding gap that is delimited by an outer lateral surface of the stator part and an inner lateral surface of the rotor part in such a way that its first end is fastened to the stator part and its second end is fastened to the rotor part.

2. The device according to claim 1 wherein:
the second cable is formed by ribbon cables.

3. The device according to claim 2 wherein:
the ribbon cables are situated in the winding gap in such a way that with a first section of their length resting against the outer lateral surface of the stator part and with a second section of their length resting against the inner lateral surface of the rotor part they are wound in opposite directions, so that a U-shaped turning section that reverses a winding direction is formed between the first and second sections of the ribbon cables.

4. The device according to claim 3 wherein:
at least one of the ribbon cables is a dummy cable without electrical strip conductors.

5. The device according to claim 1 wherein:
the return apparatus is a spring.

6. The device according to claim 1 wherein:
the return apparatus is a geared coupling to relative movement of the first and second contact points.

7. The device according to claim 1 wherein:
the first contact point is a first connector; and
the second contact point is a second connector.

8. A coil spring arrangement for providing an electrically conductive connection between first and second contact points that can be linearly moved relative to one another, the coil spring arrangement comprising:
a stator;
a drum forming a rotor, the rotor being rotatable with respect to the stator;
a first cable having a first end and a second end;
a second cable having a first end and a second end; and
a cable connection point;
the first end of the first cable being electrically connectable to the first contact point, the first end of the second cable being electrically connectable to the second contact point, and the second ends of the first and second cables being electrically connected to one another at the cable connection point;
the first cable being unwindable from the drum against a force of a return apparatus; and
the second cable being situated in a winding gap that is delimited by an outer surface of the stator and an inner surface of the rotor in such a way that the first end of the second cable is fastened to the stator and the second end of the second cable is fastened to the rotor.

9. The coil spring arrangement of claim 8 wherein:
the second cable is formed by at least one ribbon cable.

10. The coil spring arrangement of claim 8 wherein:
the second cable is formed by a plurality of individual ribbon cables, a first section of the ribbon cables resting against the outer surface of the stator and a second section of the ribbon cables resting against the inner surface of the rotor, the first and second sections of the ribbon cables being wound in opposite directions so that a U-shaped turning section that reverses a winding direction is formed between the first and second sections of the ribbon cables.

11. The coil spring arrangement of claim 10 wherein:
at least one of the ribbon cables is a dummy cable without electrical strip conductors.

12. The coil spring arrangement of claim 8 wherein:
the first contact point is a first connector; and
the second contact point is a second connector.

13. An assembly comprising:
first and second contact parts that are linearly movable relative to one another;
a coil spring arrangement including a stator and a rotor that is rotatable with respect to the stator, a first cable having a first end and a second end, a second cable having a first end and a second end, and a cable connection point;
the first contact part being electrically connected to the first end of the first cable, the second contact part being electrically connected to the first end of the second cable, and the second ends of the first and second cables being electrically connected to one another at the cable connection point whereby an electrically conductive connection is provided between the first and second contact parts;
the first cable being unwindable with rotation of the rotor against a force of a return apparatus; and
the second cable being situated in a winding gap, delimited by an outer surface of the stator and an inner surface of the rotor, in such a way that the first end of the second cable is fastened to the stator and the second end of the second cable is fastened to the rotor.

14. The assembly of claim 13 wherein:
the second cable is formed by at least one ribbon cable.

15. The assembly of claim 13 wherein:
the second cable is formed by a plurality of individual ribbon cables, a first section of the ribbon cables resting against the outer surface of the stator and a second section of the ribbon cables resting against the inner surface of the rotor, the first and second sections of the ribbon cables being wound in opposite directions so that a U-shaped turning section that reverses a winding direction is formed between the first and second sections of the ribbon cables.

16. The assembly of claim 15 wherein:
at least one of the ribbon cables is a dummy cable without electrical strip conductors.

17. The assembly of claim 13 wherein:
the first contact part is a first connector; and
the second contact part is a second connector.

18. The assembly of claim 17 wherein:
the first connector is of a first cable harness; and
the second connector is of a second cable harness.

19. The assembly of claim 18 wherein:
the first cable harness is a seat cable harness.

20. The assembly of claim 19 wherein:
the first connector is linearly movable relative to the second connector.
